(19) United States
(12) Patent Application Publication
(10) Pub. No.: US 2016/0271836 A1
(43) Pub. Date: Sep. 22, 2016

(54) METHODS AND APPARATUS FOR EXTRUDING RECYCLED PLASTICS

(71) Applicant: CRORME LIMITED, Wilmslow, Cheshire (GB)

(72) Inventor: Chesney Richard Orme, Cheshire (GB)

(21) Appl. No.: 14/442,277

(22) PCT Filed: Nov. 12, 2013
(86) PCT No.: PCT/GB2013/000482

§ 371 Date: May 12, 2015

(30) Foreign Application Priority Data
Nov. 12, 2012 (GB) 1220315.4

(51) Int. Cl. B29B 7/42; B29B 13/02; B29B 17/02

(52) U.S. Cl. CPC B29B 7/42; B29B 17/02; B29B 13/022; B29B 2017/0203; B29B 2017/0241; B29B 2017/0244; B29K 2105/16

(57) ABSTRACT

Methods and apparatus for extruding mixed granulated plastics (22) having different melting temperatures, comprising feeding the granulated plastics segregated into lots (26,27) melting at different temperatures into a barrel extruder at different inlets (13a, 13b, 13c) along the barrel.

This invention relates to extruding plastics, more particularly, but not exclusively, to extruding mixed plastics such as are recovered from waste material such as industrial waste or household waste. Recycled plastics materials can be fashioned into items such as railway sleepers, fence posts and other structural elements, particularly by extrusion.

Conventional ways of reprocessing such mixtures involve granulating the plastics and melting at the melting temperature of the plastic with the lowest melting temperature, leaving the higher melting temperature plastics as a solid filler. It is usual to add blowing agents to make a lightweight product. However, what can then happen is that the bubbles created by the blowing agents in the molten plastic matrix come into contact with the unmelted polymer granules and burst, giving rise to voids within the matrix that are points of weakness, and the product is not structurally sound. Moreover, the presence of too much solid filler makes the mixture difficult if not impossible to extrude

The present invention provides a method for extruding mixed granulated plastics having different melting temperatures, comprising feeding the granulated plastics segregated into lots melting at different temperatures into a barrel extruder at different inlets along the barrel.

The higher melting plastics may be introduced first and the lower melting plastics added to the higher melting plastics as they flow along the barrel.

A blowing agent may be introduced, and may be introduced after all the plastics have been introduced. Fillers, in particulate, powder or fibre form, may also be added at this stage.

With mixed waste plastics, particularly as are collected from households for recycling, the entire mix may be granulated to form a mix of granulated plastics, and then separated into different melting temperature lots. Plastics melting at different temperatures will have different properties, by which they may be sorted. In general, plastics melting at higher temperatures are denser than plastics melting at lower temperatures, and mixed granulated plastics may conveniently be sorted by density, either into those that sink and those that float in water, or in an upwardly moving airstream, which is preferred as it avoids a drying step. However, the choice of separation method may depend on the relative abundances of different plastics materials in the mix.

These are rather coarse methods for separating plastics, but they are perfectly adequate as preparation for extrusion, and in general it will not matter if small amounts of high melting plastic are mixed in with lower melting plastics and vice versa. Generally speaking, the precise composition of the end product is not of importance—it will suffice if the material can be extruded at all and has One, two or more separations may be carried out to produce two, three or more lots of granules.

The separated granules are fed into a barrel extruder, which may be a single or double screw extruder, at different points along the barrel, the first to be introduced being the higher melting plastics.

The invention also comprises apparatus for extruding mixed granulated plastics having different melting temperatures, comprising a barrel extruder having multiple inlets along the barrel for plastics that melt at different temperature separately.

The barrel may have at least two inlets.

There may be a further inlet or further inlets adapted for introducing fillers and/or blowing agents.

The extruder may comprise heating means to melt the plastics in the extruder or to maintain them in the molten state. Plastics in the extruder may, of course, be heated by conversion to heat of the work done on them by the extruder.

The apparatus may also comprise separator means for separating granulated mixed plastics into separate lots which melt at different temperatures. Separator means may comprise density sorting means for separating granules of different densities, which may comprise water flotation means and/or upwardly directed air column means.

The method and apparatus are suitable for use with a moulding device as described in GB2437938, the output of the extruder being fed into the moulding device.

A production line may include a granulator delivering granules to the separator means, the extruder and a moulding device.

Methods and apparatus for extruding mixed granulated plastics according to the invention will now bee described with reference to the accompanying drawings, in which:

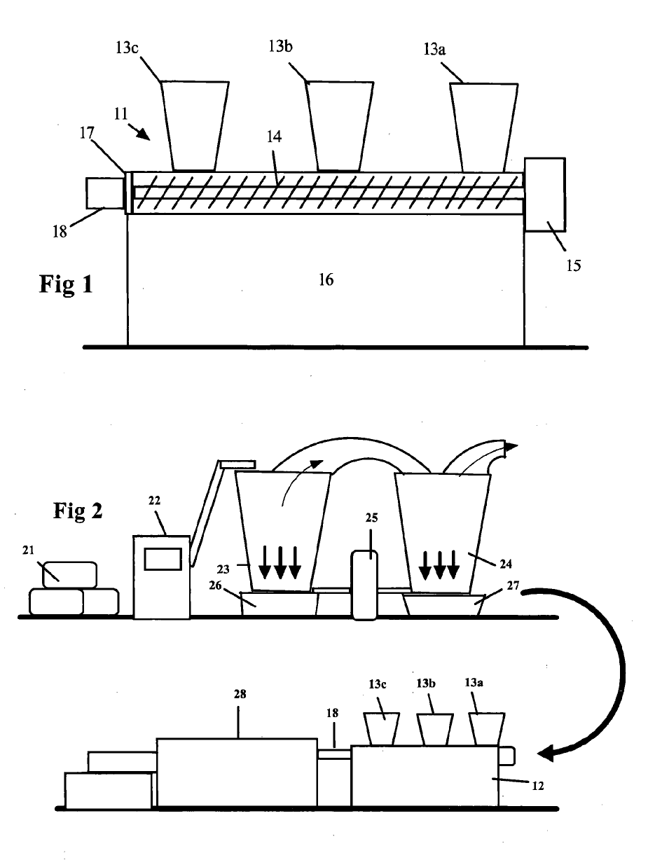

FIG. 1 is a cutaway elevation of an extruder; and

FIG. 2 is a diagrammatic illustration of a plant for granulating, extruding and moulding mixed waste plastics materials.

The drawings illustrate apparatus 11 for extruding mixed granulated plastics having different melting temperatures, comprising a barrel extruder 12 having two inlets 13a, 13b along the barrel for plastics that melt at different temperatures separately. Illustrated is a single screw extruded having a screw 14 and a drive motor 15 standing on a base 16 housing the usual heater and temperature and other controls, a breaker plate 17 and a feed pipe 18.

The inlets 13a, 13b are hoppers feeding granules into the barrel of the extruder 12 by gravity. Inlet 13a, at the input end of the extruder is fed with higher melting temperature granules, inlet 13b with lower melting temperature granules.

A third inlet hopper 13c can be used to add fillers such as powders, solid granules or fibres for reinforcement and/or a blowing agent.

Feeding high melting temperature granules first, and melting them all avoids the possibility of unmelted granules clumping together and clogging the extruder, and unmelted granules persisting to the stage where blowing agent is added, which can give rise to weaknesses in the eventual product by bubbles bursting around the granules. The addition of low melting temperature granules to a substantially completely melted flow of material results in a substantially homogeneous dispersion of the different plastics materials.

FIG. 2 illustrates the extruder 12 in a production line. Bales 21 of mixed plastics materials, for example from municipal refuse sorting sites, are fed into a granulator 22 and from there to a first separator 23 comprising a chamber in which a blower 25 generates an upward flow of air sufficient to carry less dense granules upwards to flow out and into an adjacent separator 24 in which an upward flow of air is sufficient to effect further separation of the less dense granules from light-weight contaminants. Denser granules fall into skips 26, 27, and are passed on to the extruder 12, where the denser granules from skip 26 are loaded into hopper 13a, lighter granules from skip 27 into hopper 13b. If desired, further granules or particulate or power or fibre fillers and/or a blowing agent may be added through hopper 13c.

Extrudate from the extruder 12 flows through feed pipe 18 into a moulding device which might be as described in GB2437938, which might be fashioned to make structural beams, railway sleepers or other such products.

1. A method for extruding mixed granulated plastics having different melting temperatures, comprising feeding the granulated plastics segregated into lots melting at different temperatures into a barrel extruder at different inlets along the barrel.

2. A method according to claim 1, in which the higher melting plastics are introduced first and the lower melting plastics added to the higher melting plastics as they flow along the barrel.

3. A method according to claim 1, in which a blowing agent is introduced.

4. A method according to claim 3, in which the blowing agent is introduced after all the plastics have been introduced.

5. A method according to claim 1, in which filler, in particulate, powder or fibre form, is also added.

6. A method according to claim 5, in which a filler is added after all the plastics have been introduced.

7. A method according to claim 1, in which granulated mixed plastics materials are sorted into lots with different melting temperatures prior to extrusion.

8. A method according to claim 7, in which the materials are sorted according to density.

9. A method according to claim 8, in which the materials are sorted in an upwardly moving airstream.

10. A method according to claim 8, in which the materials are sorted into those that sink or float in water.

11. A method according to claim 7, in which separated granules are fed into a barrel extruder at different points along the barrel.

12. A method according to claim 11, in which the first granules to be introduced are the higher melting plastics.

13. Apparatus for extruding mixed granulated plastics having different melting temperatures, comprising a barrel extruder having multiple inlets along the barrel for plastics that melt at different temperature separately.

14. Apparatus according to claim 13, in which the barrel has at least two inlets.

15. Apparatus according to claim 14, in which the barrel has three inlets.

16. Apparatus according to claim 13, in which the extruder comprises heating means to melt the plastics in the extruder or to maintain them in the molten state.

17. Apparatus according to claim 13, comprising separator means for separating granulated mixed plastics into separate lots which melt at different temperatures.

18. Apparatus according to claim 17, in which the separator means comprise density sorting means for separating granules of different densities.

19. Apparatus according to claim 18, comprising water flotation means.

20. Apparatus according to claim 18, comprising upwardly directed air column means.

21. (canceled)

22. A plastics moulding production line comprising a granulator delivering granules to the separator means and an extruder according to claim 13, and a moulding device.

23. (canceled)
